(19) United States
(12) Patent Application Publication
(10) Pub. No.: US 2024/0080418 A1
(43) Pub. Date: Mar. 7, 2024

(54) ILLUMINATION SYSTEM AND PROJECTION DEVICE

(71) Applicant: Coretronic Corporation, Hsin-Chu (TW)

(72) Inventor: Min-Chang Chang, Hsin-Chu (TW)

(73) Assignee: Coretronic Corporation, Hsin-Chu (TW)

(21) Appl. No.: 18/460,670

(22) Filed: Sep. 4, 2023

(30) Foreign Application Priority Data
Sep. 7, 2022 (CN) 202211087476.4

(51) Int. Cl. H04N 9/31

(52) U.S. Cl. CPC H04N 9/3152; H04N 9/317

(57) ABSTRACT

An illumination system including a light-emitting element, a wavelength conversion element, at least a first light homogenizing element and a second light homogenizing element is provided. The wavelength conversion element is configured to convert the excitation light beam into a conversion light beam, and through the wavelength conversion element, the excitation light beam and the conversion light beam sequentially form an illumination light beam. The at least one first light homogenizing element is configured to adjust a shape of a light spot formed by the excitation light beam on the wavelength conversion element. The second light homogenizing element is disposed on a transmission path of the illumination light beam from the wavelength conversion element, wherein a shape of a light incident surface of the at least one first light homogenizing element is the same as a shape of a light incident surface of the second light homogenizing element.

### CROSS-REFERENCE TO RELATED APPLICATION

This application claims the priority benefit of China application serial no. 202211087476.4, filed on Sep. 7, 2022. The entirety of the above-mentioned patent application is hereby incorporated by reference herein and made a part of this specification.

### BACKGROUND

### Technical Field

The invention relates to an optical system, and particularly relates to an illumination system and a projection device.

### Description of Related Art

In a current structure of a projection device, a lens array is usually arranged on a transmission path of an excitation light beam, so that light energy incident on a wavelength conversion device may be uniformly distributed. Since each microlens on the lens array is mostly square (a square or rectangle), light spots formed by the excitation light beam on incident ends of the wavelength conversion device and a light homogenizing element (for example, a light integration rod) after passing through the lens array are square light spots. In this way, in a structure using a slant light homogenizing element (slant light integration rod), a light beam may not fill the incident end of the light homogenizing element, resulting in decrease in light conversion efficiency of the light homogenizing element. Alternatively, a part of the light beam is incident on a periphery of the incident end of the light homogenizing element, resulting in loss of light energy of the light homogenizing element.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to an illumination system and a projection device, which are adapted to reduce loss of light energy and improve a light output brightness of the illumination system.

Other objects and advantages of the invention may be further illustrated by the technical features broadly embodied and described as follows.

In order to achieve one or a portion of or all of the objects or other objects, an embodiment of the invention provides an illumination system including a light-emitting element, a wavelength conversion element, at least a first light homogenizing element and a second light homogenizing element. The light-emitting element is configured to provide an excitation light beam. The wavelength conversion element is disposed on a transmission path of the excitation light beam and is configured to convert the excitation light beam into a conversion light beam, and through the wavelength conversion element, the excitation light beam and the conversion light beam sequentially form an illumination light beam. The illumination light beam includes at least one of the excitation light beam and the conversion light beam. The at least one first light homogenizing element is disposed on the transmission path of the excitation light beam from the light-emitting element, and is located between the light-emitting element and the wavelength conversion element. The at least one first light homogenizing element is configured to adjust a shape of a light spot formed by the excitation light beam on the wavelength conversion element. The second light homogenizing element is disposed on a transmission path of the illumination light beam from the wavelength conversion element, wherein a shape of a light incident surface of the at least one first light homogenizing element is the same as a shape of a light incident surface of the second light homogenizing element.

In order to achieve one or a portion of or all of the objects or other objects, an embodiment of the invention provides a projection device includes an illumination system, a light valve and a projection lens. Wherein, the illumination system is configured to provide an illumination light beam. The illumination system includes a light-emitting element, a wavelength conversion element, at least one first light homogenizing element and a second light homogenizing element. The light-emitting element is configured to provide an excitation light beam. The wavelength conversion element is disposed on a transmission path of the excitation light beam and is configured to convert the excitation light beam into a conversion light beam, and through the wavelength conversion element, the excitation light beam and the conversion light beam sequentially form an illumination light beam. The illumination light beam includes at least one of the excitation light beam and the conversion light beam. The at least one first light homogenizing element is disposed on the transmission path of the excitation light beam from the light-emitting element, and is located between the light-emitting element and the wavelength conversion element. The at least one first light homogenizing element is configured to adjust a shape of a light spot formed by the excitation light beam on the wavelength conversion element. The second light homogenizing element is disposed on a transmission path of the illumination light beam from the wavelength conversion element, wherein a shape of a light incident surface of the at least one first light homogenizing element is the same as a shape of a light incident surface of the second light homogenizing element. The light valve is disposed on the transmission path of the illumination light beam from the second light homogenizing element, and is configured to convert the illumination light beam into an image light beam. The projection lens is arranged on a transmission path of the image light beam, and is configured to project the image light beam out of the projection device.

In an embodiment of the invention, the shape of the light incident surface of the at least one first light homogenizing element is a quadrilateral, and at least one interior angle of the light incident surface is not equal to 90 degrees.

In an embodiment of the invention, the shape of the light incident surface of the second light homogenizing element is a quadrilateral, and at least one interior angle of the light incident surface is not equal to 90 degrees.

In an embodiment of the invention, the shape of the light spot formed on the wavelength conversion element is a quadrilateral, at least one interior angle of the quadrilateral is not equal to 90 degrees, and the at least one interior angle of the quadrilateral is the same as at least one interior angle of the light incident surface of the at least one first light homogenizing element.

In an embodiment of the invention, an area of the light incident surface of the second light homogenizing element is larger than an area of the light incident surface of the at least one first light homogenizing element.

In an embodiment of the invention, the illumination system further includes a lens group, which is disposed on the transmission path of the excitation light beam, the lens group includes at least two lenses, and the at least one first light homogenizing element is disposed between the at least two lenses.

In an embodiment of the invention, the illumination system further includes a filter element, which is disposed on the transmission path of the illumination light beam from the wavelength conversion element, and is located between the wavelength conversion element and the second light homogenizing element.

In an embodiment of the invention, the illumination system further includes a beam splitter set, which is disposed on the transmission path of the excitation light beam and the illumination light beam, and configured to guide the excitation light beam from the light-emitting element to the wavelength conversion element, and guide the illumination light beam from the wavelength conversion element to the second light homogenizing element.

In an embodiment of the invention, a number of the at least one first light homogenizing element is plural, and the plurality of first light homogenizing elements are arranged in an array in a direction perpendicular to a transmission direction of the excitation light beam from the light-emitting element.

In an embodiment of the invention, the at least one first light homogenizing element and/or the second light homogenizing element is formed by four optical sheets.

In an embodiment of the invention, the at least one first light homogenizing element and/or the second light homogenizing element is composed of a light transmissive body.

In an embodiment of the invention, a shape of a light spot formed by the illumination light beam on the light valve is a rectangle.

Based on the above description, the embodiments of the invention have at least one of the following advantages or effects. In the illumination system and the projection device of the embodiment of the invention, the shape of the light incident surface of the first light homogenizing element is the same as the shape of the light incident surface of the second light homogenizing element, and the shape of the light spot formed by the excitation light beam on the wavelength conversion element is also the same as the shape of the light incident surface of the first light homogenizing element and the light incident surface of the second light homogenizing element, so that the light spot formed by the illumination light beam on the second light homogenizing element may completely cover the light incident surface of the second light homogenizing element. In this way, an area of the excitation light beam irradiating the wavelength conversion element may be enlarged and energy may be evenly distributed, thereby improving the conversion efficiency of the wavelength conversion element, reducing optical energy loss of the illumination light beam incident to the second light homogenizing element, and improving a light output brightness of the illumination system.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the invention.

FIG. 2 is a schematic diagram of an illumination system according to an embodiment of the present invention.

FIG. 3A is a schematic three-dimensional view of a first light homogenizing element and a second light homogenizing element according to an embodiment of the invention.

FIG. 3B is a schematic front view of the first light homogenizing element and the second light homogenizing element according to an embodiment of the invention.

FIG. 4 is a schematic diagram of a wavelength conversion element according to an embodiment of the invention.

FIG. 5 is a schematic diagram of an illumination system according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

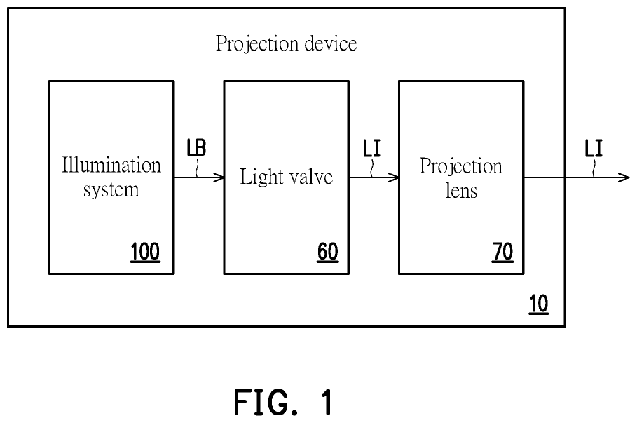

FIG. 1 is a schematic diagram of a projection device according to an embodiment of the invention. Referring to FIG. 1, a projection device 10 of the embodiment includes an illumination system 100, a light valve 60 and a projection lens 70. The illumination system 100 is configured to provide an illumination light beam LB. The light valve 60 is disposed on a transmission path of the illumination light beam LB, and is configured to convert the illumination light beam LB into an image light beam LI. The projection lens 70 is disposed on a transmission path of the image light beam LI, and is configured to project the image light beam LI out of the projection device 10 and onto a projection target (not shown), such as a screen or a wall. In addition, an optical structure of the projection device 10 and the projection lens 70 of the embodiment may have a design of a telecentric system or a non-telecentric system.

The light valve 60 is, for example, a reflective light modulator such as a liquid crystal on silicon panel (LCoS panel), a digital micro-mirror device (DMD), etc. In some embodiments, the light valve 60 may also be a transmissive light modulator such as a transparent liquid crystal panel, an electro-optical modulator, a magneto-optic modulator, an acousto-optic modulator (AOM), etc. The embodiment of the invention does not limit the pattern and type of the light valve 60. Detailed steps and implementation of the method for the light valve 60 to convert the illumination light beam LB into the image light beam LI may be adequately taught, suggested and implemented from the common knowledge in the related technical field, and thus will not be repeated here. In the embodiment, a number of the light valve 60 is one, for example, the projection device 10 using a single digital micro-mirror device is introduced, in other embodiments, the number of the light valves 60 may also be multiple.

The projection lens 70 includes, for example, a combination of one or more optical lenses having dioptric powers, such as various combinations of non-planar lenses including a biconcave lens, a biconvex lens, a concavo-convex lens, a convexo-concave lens, a plano-convex lens, a plano-concave lens, etc. In an embodiment, the projection lens 70 may further include a planar optical lens to project the image light beam LI from the light valve 60 to a projection target in a reflective manner. The embodiment of the invention does not limit the pattern and type of the projection lens 70.

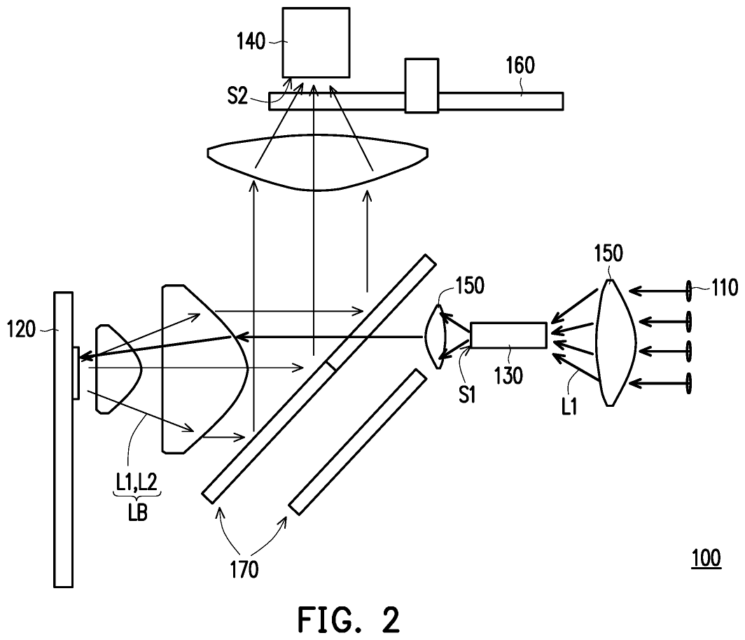

FIG. 2 is a schematic diagram of an illumination system according to an embodiment of the present invention. Referring to FIG. 1 and FIG. 2 at the same time, the illumination system 100 of the embodiment may be at least applied to the projection device 10 shown in FIG. 1. The illumination system 100 includes a light-emitting element 110, a wavelength conversion element 120, at least one first light homogenizing element 130 and a second light homogenizing element 140. In the embodiment, the illumination system 100 may further include a lens group 150, a filter element 160 and a beam splitter set 170.

The light-emitting element 110 is configured to provide an excitation light beam L1. For example, the light-emitting element 110 includes, for example, a light-emitting diode (LED), a laser diode (LD) or a combination thereof, or other suitable light sources. The excitation light beam L1 is, for example, a blue light beam. The embodiment of the invention does not specifically limit the type and configuration number of the light-emitting elements 110, and detailed structures and implementations thereof may be adequately taught, suggested, and implemented by common knowledge in the related technical field, and thus will not be repeated here.

The wavelength conversion element 120 is disposed on a transmission path of the excitation light beam L1, and is configured to convert the excitation light beam L1 into a conversion light beam L2, such as converting the blue light beam into a yellow light beam, a green light beam and/or a red light beam. In the embodiment, the wavelength conversion element 120 includes at least one conversion region 122 and an optical region 124. For example, the at least one conversion region 122 is configured to convert the excitation light beam L1 and includes yellow light, yellow-green light or red light conversion materials (for example, a phosphor material). The optical region 124 is configured to reflect the excitation light beam L1 and includes reflective materials. The wavelength conversion element 120 is, for example, a rotatable phosphor wheel, and the at least one conversion region 122 and the optical region 124 move to the transmission path of the excitation light beam L1 sequentially. The wavelength conversion element 120 is configured to sequentially convert the excitation light beam L1 into the conversion light beam L2 and reflect the excitation light beam L1. Therefore, by using the wavelength conversion element 120, the excitation light beam L1 and the conversion light beam L2 sequentially form the illumination light beam LB. Namely, the illumination light beam LB includes at least one of the excitation light beam L1 and the conversion light beam L2.

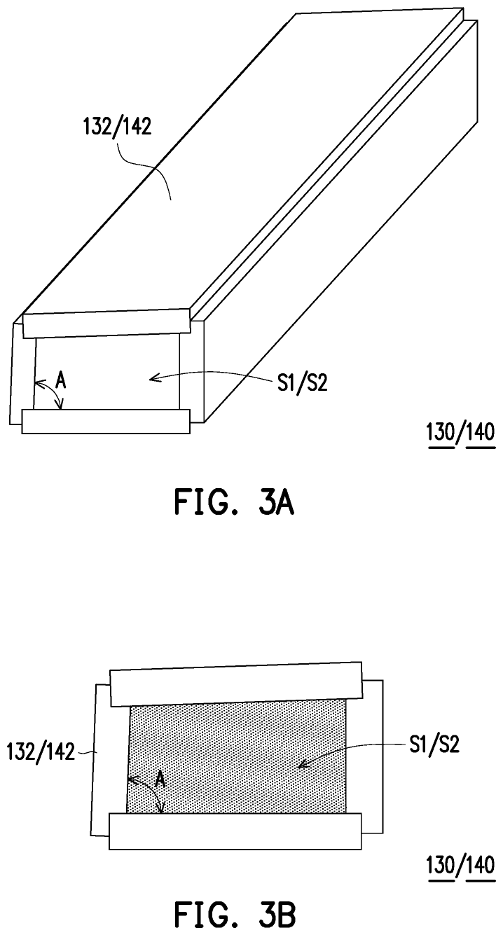

FIG. 3A is a schematic three-dimensional view of a first light homogenizing element and a second light homogenizing element according to an embodiment of the invention. FIG. 3B is a schematic front view of the first light homogenizing element and the second light homogenizing element according to an embodiment of the invention. Referring to FIG. 2 to FIG. 3B, at least one first light homogenizing element 130 is disposed on the transmission path of the excitation light beam L1 from the light-emitting element 110, and is located between the light-emitting element 110 and the wavelength conversion element 120. In the embodiment, as shown in FIG. 3B, the first light homogenizing element 130 may be formed by, for example, four optical sheets 132 arranged to form a hollow cuboid, and the optical sheets 132 are, for example, glass or mirrors. The interior of the first light homogenizing element 130 is hollow, and the excitation light beam L1 passes through an opening surrounded by the four optical sheets 132 and is transmitted to the interior of the first light homogenizing element 130. A shape of a light incident surface S1 of the first light homogenizing element 130 is defined by inner edges of the four optical sheets 132. In the embodiment, the light incident surface S1 is a surface of the opening of the first light homogenizing element 130. In another embodiment, the first light homogenizing element 130 may be a light transmissive body made of a solid light transmissive material (for example, glass), and the excitation light beam L1 passes through the light transmissive body. The shape of the light incident surface S1 of the first light homogenizing element 130 is defined by a shape of the light transmissive body.

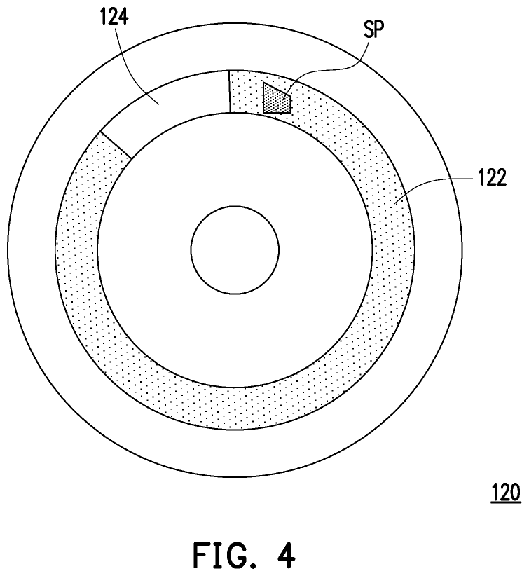

FIG. 4 is a schematic diagram of a wavelength conversion element according to an embodiment of the invention. Referring to FIG. 3B and FIG. 4 at the same time, in the embodiment, the shapes of the light incident surface S1 and a light spot SP in FIGS. 3A, 3B and 4 are only an example, and may be adjusted according to actual usage requirements. The first light homogenizing element 130 is configured to adjust the shape of the light spot SP formed by the excitation light beam L1 on the wavelength conversion element 120. The light incident surface S1 of the first light homogenizing element 130 is a surface where the excitation light beam L1 enters the first light homogenizing element 130 along the transmission direction of the excitation light beam L1. It should be noted that, in the embodiment, the shape of the light incident surface S1 of the first light homogenizing element 130 is a quadrilateral, and at least one interior angle A of the light incident surface S1 is not equal to 90 degrees. Namely, the light incident surface S1 is not rectangular. The light incident surface S1 may be, for example, a parallelogram, a trapezoid or an irregular quadrilateral. The first light homogenizing element 130 is, for example, a slant light integration rod. In the embodiment, a number of the first light homogenizing elements 130 is one, and the shape of the light spot SP formed by the excitation light beam L1 on the wavelength conversion element 120 is determined by the shape of the light incident surface S1 of the first light homogenizing element 130. The shape of the light spot SP formed on the wavelength conversion element 120 is a quadrilateral, and at least one inner angle of the quadrilateral is not equal to 90 degrees. At least one interior angle of the quadrilateral of the light spot SP is the same as the at least one interior angle A of the light incident surface S1 of the first light homogenizing element 130. In the embodiment, viewed along a transmission direction of the excitation light beam L1, the shape of the light spot SP on the wavelength conversion element 120 is the same as the shape of the light incident surface S1 of the first light homogenizing element 130, i.e., the four interior angles of the light spot SP are the same as the four interior angles of the light incident surface Si, and the light spot SP and the light incident surface S1 are all parallelograms, trapezoids or irregular quadrilaterals. Since the excitation light beam L1 may first pass through the first light homogenizing element 130 before entering the wavelength conversion element 120, and through the first light homogenizing element 130, an effect of shaping the light spot is achieved, an area of the light spot SP formed by the excitation light beam L1 on the wavelength conversion element 120 may be enlarged, i.e., an energy density per unit area may be reduced, thereby improving the conversion efficiency of the wavelength conversion element 120.

Referring to FIG. 2, the lens group 150 is disposed on the transmission path of the excitation light beam L1, in the embodiment, the lens group 150 includes at least two lenses, and the first light homogenizing element 130 is disposed between the at least two lenses. For example, in the embodiment, the lens group 150 includes two lenses. After the excitation light beam L1 from the light-emitting element 110 is transmitted through one of the lenses in a parallel light manner, the excitation light beam L1 is transmitted into the first light homogenizing element 130 in a converging manner, and the excitation light beam L1 passing through the first light homogenizing element 130 is transmitted through the other one of the lenses in a divergent manner, and is transmitted to the wavelength conversion element 120. In the embodiment, the effect of reducing the volume of the first light homogenizing element 130 may be achieved.

The beam splitter set 170 is disposed on the transmission path of the excitation light beam L1 and the illumination light beam LB, and is configured to guide the excitation light beam L1 from the light-emitting element 110 to the wavelength conversion element 120, and guide the illumination light beam LB from the wavelength conversion element 120 to the second light homogenizing element 140. In the embodiment, the beam splitter set 170 is, for example, a dichroic mirror with yellow reflect (DMY), a dichroic mirror with blue reflect (DMB), a dichroic mirror/a reflecting mirror for other wavelength bands, or any combination thereof. The embodiment of the invention does not limit the pattern and type of the beam splitter set 170.

Referring to FIG. 2 to FIG. 3B again, the second light homogenizing element 140 is disposed on the transmission path of the illumination light beam LB from the wavelength conversion element 120. In the embodiment, the light incident surface S2 of the second light homogenizing element 140 is a surface from which the illumination light beam LB enters the second light homogenizing element 140 along the transmission direction of the illumination light beam LB. Viewed along the transmission direction of the excitation light beam L1 and the illumination light beam LB, the shape of the light incident surface S1 of the first light homogenizing element 130 is the same as the shape of the light incident surface S2 of the second light homogenizing element 140. Similar to the first light homogenizing element 130, in the embodiment, the shape of the light incident surface S2 of the second light homogenizing element 140 is a quadrilateral, and at least one interior angle A of the light incident surface S2 is not equal to 90 degrees. The four interior angles of the light incident surface S2 of the second light homogenizing element 140 are the same as the four interior angles of the light incident surface S1 of the first light homogenizing element 130. Both of the light incident surface S2 of the second light homogenizing element 140 and the light incident surface S1 of the first light homogenizing element 130 are irregular quadrilaterals (at least one interior angle is not equal to 90 degrees). The second light homogenizing element 140 is, for example, a slant light integration rod. As shown in FIG. 3B, the second light homogenizing element 140 may be formed by, for example, four optical sheets 142 arranged to form a hollow cuboid, and the optical sheets 142 are, for example, glass or mirrors. The interior of the second light homogenizing element 140 is hollow, and a shape of the light incident surface S2 of the second light homogenizing element 140 is defined by inner edges of the four optical sheets 142. In the embodiment, the light incident surface S2 is a surface of the opening of the second light homogenizing element 140. In another embodiment, the second light homogenizing element 140 may be a light transmissive body made of a solid light transmissive material (for example, glass), and the shape of the light incident surface S2 of the second light homogenizing element 140 is defined by a shape of the light transmissive body. In the embodiment, the area of the light incident surface S2 of the second light homogenizing element 140 is larger than the area of the light incident surface S1 of the first light homogenizing element 130, for example, the area of the light incident surface S2 of the second light homogenizing element 140 is 2 to 4 times of that of the light incident surface S1 of the first light homogenizing element 130. A size magnification relationship between the second light homogenizing element 140 and the first light homogenizing element 130 may be adjusted according to the actual usage requirements.

The filter element 160 is disposed on the transmission path of the illumination light beam LB from the wavelength conversion element 120, and is located between the wavelength conversion element 120 and the second light homogenizing element 140. The filter element 160 includes, for example, a plurality of filter regions corresponding to different wavelengths, a diffusion region, a light transmissive region, or any combination thereof. The filter element 160 is, for example, a rotatable filter color wheel device (filter wheel), which is configured to sequentially switch the above-mentioned regions to allow light of a specific wavelength in the illumination light beam LB to pass through. The embodiment of the invention does not limit the pattern or type of the filter element 160, and its detailed structure and implementation may be adequately taught, suggested, and implemented by common knowledge in the related technical field, and thus will not be repeated here.

Since the shape of the light incident surface S1 of the first light homogenizing element 130 is the same as the shape of the light spot SP on the wavelength conversion element 120, and the shape of the light spot SP on the wavelength conversion element 120 is the same as the shape of the light incident surface S2 of the second light homogenizing element 140, the shape of the light incident surface S1 of the first light homogenizing element 130 is the same as the shape of the light incident surface S2 of the second light homogenizing element 140. Before the excitation light beam L1 is transmitted to the wavelength conversion element 120, the first light homogenizing element 130 is used to achieve the effect of shaping the light spot, thereby improving the conversion efficiency of the wavelength conversion element 120. As the shape of the light incident surface S1 of the first light homogenizing element 130 is the same as the shape of the light incident surface S2 of the second light homogenizing element 140, optical energy loss may be reduced and the light output brightness of the illumination system 100 may be improved. In addition, after the illumination light beam LB passes through the second light homogenizing element 140, the shape of the light spot formed on the light valve 60 is a rectangle, for example, a square or a rectangle. In this way, the light spot formed by the illuminating light beam LB entering the light valve 60 matches the shape of the light valve 60, which may achieve the effect of good optical efficiency.

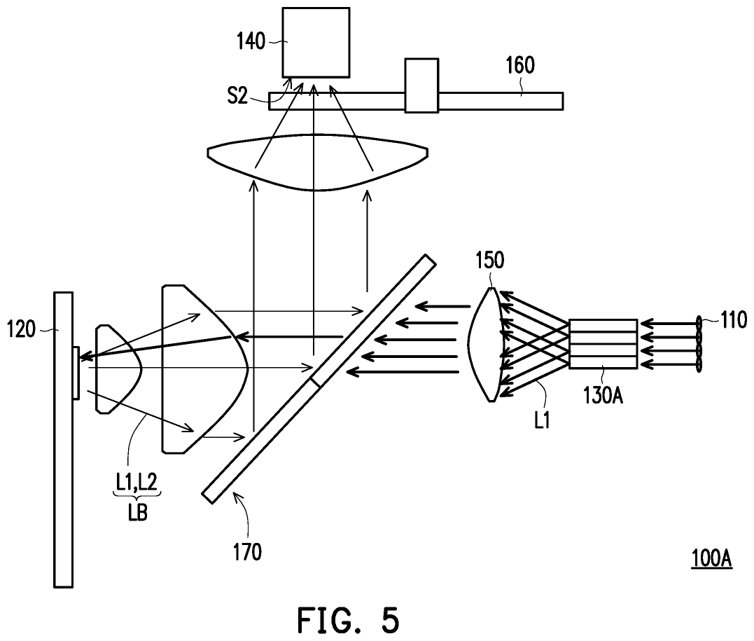

FIG. 5 is a schematic diagram of an illumination system according to another embodiment of the invention. Referring to FIG. 5, an illumination system 100A of the embodiment is similar to the illumination system 100 shown in FIG. 2, and differences there between are that in the embodiment, the number of the first light homogenizing elements 130A is multiple, and the plurality of first light homogenizing elements 130A are arranged in an array in a direction perpendicular to the transmission direction of the excitation light beam L1 from the light-emitting element 110. At least one interior angle of a light incident surface of each first light homogenizing element 130A is not equal to 90 degrees, and a shape of the light incident surface of each first light homogenizing element 130A is the same. More specifically, the four interior angles of the light incident surface of each of the first light homogenizing elements 130A are the same as the four interior angles of the light incident surface S2 of the second light homogenizing element 140. In the embodiment, a plurality of light-emitting elements 110 may be further configured, and the positions of the plurality of first light homogenizing elements 130A on the optical axis are arranged corresponding to the light-emitting elements 110, thereby the number of lenses in the lens group 150 may be reduced.

In summary, in the illumination system and the projection device of the embodiment of the invention, the shape of the light incident surface of the first light homogenizing element is the same as the shape of the light incident surface of the second light homogenizing element, and the shape of the light spot formed by the excitation light beam on the wavelength conversion element is also the same as the shape of the light incident surface of the first light homogenizing element and the light incident surface of the second light homogenizing element, so that the light spot formed by the illumination light beam on the second light homogenizing element may completely cover the light incident surface of the second light homogenizing element. In this way, an area of the excitation light beam irradiating the wavelength conversion element may be enlarged and energy may be evenly distributed, thereby improving the conversion efficiency of the wavelength conversion element, reducing optical energy loss of the illumination light beam incident to the second light homogenizing element, and improving a light output brightness of the illumination system.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising a light-emitting element, a wavelength conversion element, at least a first light homogenizing element and a second light homogenizing element, wherein:
the light-emitting element is configured to provide an excitation light beam;
the wavelength conversion element is disposed on a transmission path of the excitation light beam and is configured to convert the excitation light beam into a conversion light beam, and through the wavelength conversion element, the excitation light beam and the conversion light beam sequentially form an illumination light beam, and the illumination light beam comprises at least one of the excitation light beam and the conversion light beam;
the at least one first light homogenizing element is disposed on the transmission path of the excitation light beam from the light-emitting element, and is located between the light-emitting element and the wavelength conversion element, and the at least one first light homogenizing element is configured to adjust a shape of a light spot formed by the excitation light beam on the wavelength conversion element; and
the second light homogenizing element is disposed on a transmission path of the illumination light beam from the wavelength conversion element, wherein a shape of a light incident surface of the at least one first light homogenizing element is the same as a shape of a light incident surface of the second light homogenizing element.

2. The illumination system as claimed in claim 1, wherein the shape of the light incident surface of the at least one first light homogenizing element is a quadrilateral, and at least one interior angle of the light incident surface is not equal to 90 degrees.

3. The illumination system as claimed in claim 1, wherein the shape of the light incident surface of the second light homogenizing element is a quadrilateral, and at least one interior angle of the light incident surface is not equal to 90 degrees.

4. The illumination system as claimed in claim 1, wherein the shape of the light spot formed on the wavelength conversion element is a quadrilateral, at least one interior angle of the quadrilateral is not equal to 90 degrees, and the at least one interior angle of the quadrilateral is the same as at least one interior angle of the light incident surface of the at least one first light homogenizing element.

5. The illumination system as claimed in claim 1, wherein an area of the light incident surface of the second light homogenizing element is larger than an area of the light incident surface of the at least one first light homogenizing element.

6. The illumination system as claimed in claim 1, further comprising:
a lens group, disposed on the transmission path of the excitation light beam, and comprising at least two lenses, wherein the at least one first light homogenizing element is disposed between the at least two lenses.

7. The illumination system as claimed in claim 1, further comprising:
a filter element, disposed on the transmission path of the illumination light beam from the wavelength conversion element, and located between the wavelength conversion element and the second light homogenizing element.

8. The illumination system as claimed in claim 1, further comprising:
a beam splitter set, disposed on the transmission path of the excitation light beam and the illumination light beam, and configured to guide the excitation light beam from the light-emitting element to the wavelength conversion element, and guide the illumination light beam from the wavelength conversion element to the second light homogenizing element.

9. The illumination system as claimed in claim 1, wherein a number of the at least one first light homogenizing element is plural, and the plurality of first light homogenizing elements are arranged in an array in a direction perpendicular to a transmission direction of the excitation light beam from the light-emitting element.

10. The illumination system as claimed in claim 1, wherein the at least one first light homogenizing element and/or the second light homogenizing element is formed by four optical sheets.

11. The illumination system as claimed in claim 1, wherein the at least one first light homogenizing element and/or the second light homogenizing element is composed of a light transmissive body.

12. A projection device, comprising an illumination system, a light valve and a projection lens, wherein
the illumination system is configured to provide an illumination light beam, and the illumination system comprises a light-emitting element, a wavelength conversion element, at least one first light homogenizing element and a second light homogenizing element, wherein:
the light-emitting element is configured to provide an excitation light beam;
the wavelength conversion element is disposed on a transmission path of the excitation light beam and is configured to convert the excitation light beam into a conversion light beam, and through the wavelength conversion element, the excitation light beam and the conversion light beam sequentially form the illumination light beam, and the illumination light beam comprises at least one of the excitation light beam and the conversion light beam;
the at least one first light homogenizing element is disposed on the transmission path of the excitation light beam from the light-emitting element, and is located between the light-emitting element and the wavelength conversion element, and the at least one first light homogenizing element is configured to adjust a shape of a light spot formed by the excitation light beam on the wavelength conversion element; and
the second light homogenizing element is disposed on a transmission path of the illumination light beam from the wavelength conversion element, wherein a shape of a light incident surface of the at least one first light homogenizing element is the same as a shape of a light incident surface of the second light homogenizing element;
the light valve is disposed on the transmission path of the illumination light beam from the second light homogenizing element, and is configured to convert the illumination light beam into an image light beam; and
the projection lens is arranged on a transmission path of the image light beam, and is configured to project the image light beam out of the projection device.

13. The projection device as claimed in claim 12, wherein the shape of the light incident surface of the at least one first light homogenizing element is a quadrilateral, and at least one interior angle of the light incident surface is not equal to 90 degrees.

14. The projection device as claimed in claim 12, wherein the shape of the light incident surface of the second light homogenizing element is a quadrilateral, and at least one interior angle of the light incident surface is not equal to 90 degrees.

15. The projection device as claimed in claim 12, wherein the shape of the light spot formed on the wavelength conversion element is a quadrilateral, at least one interior angle of the quadrilateral is not equal to 90 degrees, and the at least one interior angle of the quadrilateral is the same as at least one interior angle of the light incident surface of the at least one first light homogenizing element.

16. The projection device as claimed in claim 12, wherein an area of the light incident surface of the second light homogenizing element is larger than an area of the light incident surface of the at least one first light homogenizing element.

17. The projection device as claimed in claim 12, wherein the illumination system further comprises a lens group disposed on the transmission path of the excitation light beam, and the lens group comprises at least two lenses, and the at least one first light homogenizing element is disposed between the at least two lenses.

18. The projection device as claimed in claim 12, wherein the illumination system further comprises a filter element disposed on the transmission path of the illumination light beam from the wavelength conversion element, and located between the wavelength conversion element and the second light homogenizing element.

19. The projection device as claimed in claim 12, wherein the illumination system further comprises a beam splitter set disposed on the transmission path of the excitation light beam and the illumination light beam, and configured to guide the excitation light beam from the light-emitting element to the wavelength conversion element, and guide the illumination light beam from the wavelength conversion element to the second light homogenizing element.

20. The projection device as claimed in claim 12, wherein a number of the at least one first light homogenizing element is plural, and the plurality of first light homogenizing elements are arranged in an array in a direction perpendicular to a transmission direction of the excitation light beam from the light-emitting element.

21. The projection device as claimed in claim 12, wherein the at least one first light homogenizing element and/or the second light homogenizing element is formed by four optical sheets.

22. The projection device as claimed in claim 12, wherein the at least one first light homogenizing element and/or the second light homogenizing element is composed of a light transmissive body.

23. The projection device as claimed in claim 12, wherein a shape of a light spot formed by the illumination light beam on the light valve is a rectangle.
